(19) United States
(12) Patent Application Publication
(10) Pub. No.: US 2008/0030908 A1
(43) Pub. Date: Feb. 7, 2008

(54) Magnetoresistive effect element, thin-film magnetic head, method for manufacturing magnetoresistive effect element, and method for manufacturing thin-film magnetic head

(75) Inventors: Takeo Kagami, Chuo-ku (JP); Kosuke Tanaka, Chuo-ku (JP); Shinji Hara, Chuo-ku (JP); Takayasu Kanaya, Chuo-ku (JP); Nobuyoshi Morizumi, Chuo-ku (JP)

Correspondence Address: FROMMER LAWRENCE & HAUG, 745 FIFTH AVENUE- 10TH FL., NEW YORK, NY, 10151, US

(73) Assignee: TDK Corporation, Chuo-ku (JP)

(21) Appl. No.: 11/812,311

(22) Filed: Jun. 18, 2007

(30) Foreign Application Priority Data
Aug. 1, 2006 (JP) 209580/2006

(51) Int. Cl. G11B 5/127

(52) U.S. Cl. 360/327.3

(57) ABSTRACT

A magnetoresistive effect (MR) element, a thin-film magnetic head having the MR element, a method for manufacturing the MR element, and a method for manufacturing the thin-film magnetic head are disclosed. The MR element, which uses electric current in a direction perpendicular to layer planes, includes a lower electrode layer, a MR multilayered structure formed on the lower electrode layer, a magnetic domain controlling bias layer that is disposed on both sides of the MR multilayered structure along the track-width direction and is made of a material at least partially including an hcp structure, a metal layer made of a material having a bcc structure formed on the magnetic domain controlling bias layer and the MR multilayered structure to cover the magnetic domain controlling bias layer and the MR multilayered structure, and an upper electrode layer formed on the metal layer.

### PRIORITY CLAIM

This application claims priority from Japanese patent application No. 2006-209580 filed on Aug. 1, 2006, which is incorporated herein by reference.

### BACKGROUND OF THE INVENTION

1. Field of the Invention

The present invention relates to a magnetoresistive effect (MR) element, a thin-film magnetic head having the MR element, a method for manufacturing the MR element, and a method for manufacturing a thin-film magnetic head having the MR element.

2. Description of the Related Art

As the recording densities of hard disk drives (HDDs) increase, highly-sensitive and high-resolution thin-film magnetic heads are being demanded. In order to meet the demand, tunnel magnetoresistive effect (TMR) thin-film magnetic heads having a TMR read head element are becoming commercially practical. TMR thin-film magnetic heads has a CPP (Current Perpendicular to Plane) structure in which sense current flows in a direction perpendicular to the film planes or layer planes, and has a higher sensitivity and resolution than thin-film magnetic heads having a giant magnetoresistive effect (GMR) read head element that has a CIP (Current In Plane) structure in which sense current flows in a direction parallel to the layer planes, and is capable of coping with densities of the order of 100 Gbpi. TMR thin-film magnetic heads are replacing conventional thin-film magnetic heads having a GMR read head element. Further, GMR thin-film magnetic heads having a GMR read head element with the CPP structure is also being developed.

A degradation mode becomes a problem of the GMR thin-film magnetic heads and TMR thin-film magnetic heads that is capable of coping with high recording densities, and have the CPP structure. The degradation mode means change of output and/or asymmetric characteristics, and caused by changing the magnetization state of magnetic layers in the read head element. The change of magnetization state occurs due to the interaction among a mechanical strain of the read head element caused by a thermal expansion, a stress caused by a crash of the thin-film magnetic head to the magnetic medium due to reducing flying height and a magnetostriction of a magnetic material itself. The cause of the thermal expansion is the heat generated by a magnetic write head element while high frequency writing and/or a heater for controlling the spacing between the head and a magnetic medium.

One cause of the degradation is imperfection of the crystallinity of a magnetic domain controlling bias layer that aligns magnetic domain of a magnetization free layer of TMR read head elements or GMR read head elements with the CPP structure.

Japanese Patent Publication No. 08-045035A and No. 2002-043655A disclose that Cr (chrome) having a body-centered cubic lattice (bcc) structure is used for the under and over layers, in case a CoCrPt (cobalt-chrome-platinum) alloy or a CoPt (cobalt-platinum) alloy having a hexagonal close-packed (hcp) structure is used for a magnetic domain controlling bias layer of an anisotropic magnetoresistive effect (AMR) read head element with single-layer structure or a GMR read head element with a CIP structure. With this configuration, the crystallinity of the crystal structure of a portion of the magnetic domain controlling bias layer can be improved under the influence of the Cr layer having the bcc structure.

Studies conducted by the present inventors have revealed that the degradation problem with GMR read head elements and TMR read head elements having the CPP structure described above is caused by changes in the magnetization state of the end portion of the magnetic domain controlling bias layer that is near the MR multilayered structure. However, both of the under and over layers under and over the end portion of the magnetic domain controlling bias layer are inevitably thin for manufacturing process reasons. In addition, the over layer must be formed as thin as possible in order to ensure the flatness of an upper shield layer to improve the track and bit resolution of the MR read head element. Therefore, even if the under and over layers are formed of Cr having a bcc structure, it is prohibitively difficult to improve the crystallinity of the end portion of the magnetic domain controlling bias layer because the end portion, which is of foremost importance, is thin. Accordingly, it is difficult to prevent variations in the magnetization state caused by mechanical strain, stress, and magnetostriction.

### SUMMARY OF THE INVENTION

Therefore, an object of the present invention is to provide a MR element, a thin-film magnetic head, a method for manufacturing the MR element and a method for manufacturing the thin-film magnetic head, in which the MR element has a high crystallinity at the end portion of a magnetic domain controlling bias layer near an MR multilayered structure.

According to the present invention, there is provided an MR element which uses electric current in a direction perpendicular to layer planes. The MR element includes a lower electrode layer, an MR multilayered structure formed on the lower electrode layer, a magnetic domain controlling bias layer made of a material at least partially including an hcp structure formed on both sides of the MR multilayered structure along the track-width direction, a metal layer made of a material having a bcc structure formed on the magnetic domain controlling bias layer and the MR multilayered structure to contiguously cover the magnetic domain controlling bias layer and the MR multilayered structure, and an upper electrode layer formed on the metal layer.

The metal layer made of a material having a bcc structure is formed on the magnetic domain controlling bias layer of a material at least partially including an hcp structure and on the MR multilayered structure to contiguously cover the magnetic domain controlling bias layer and the MR multilayered structure. Accordingly, a sufficiently thick metal layer of the material having the bcc structure is present on the end portion of the magnetic domain controlling bias layer near the MR multilayered structure and therefore the crystallinity of that portion of the magnetic domain controlling bias layer can be sufficiently increased. Consequently, the c-axis which is the axis of easy magnetization of the magnetic domain controlling bias layer can be directed to the in-plane direction of the MR multilayered structure to provide a sufficient bias magnetic filed to the magnetization free layer of the MR multilayered structure. Thus, degradation of the MR read head element which would otherwise be caused by a mechanical strain resulting from thermal expansion, a stress by an impact, or magnetostriction can be effectively prevented.

The metal layer is preferably a single metal layer contiguously formed to cover the magnetic domain controlling bias layer and the MR multilayered structure. Or the metal layer includes a first metal layer formed only on the magnetic domain controlling bias layer and a second metal layer formed on the first metal layer and the MR multilayered structure.

The MR element preferably includes an under layer that is formed under the magnetic domain controlling bias layer and is made of a material having a bcc structure. In this case, the MR element more preferably includes an insulation layer formed under the under layer. In the latter case, the metal layer and the under layer are preferably made of the same material having a bcc structure.

The material having a bcc structure is preferably at least one of Cr (chrome), W (tungsten), Ti (titanium), Mo (molybdenum), a CrTi (chrome-titanium) alloy, a TiW (titanium-tungsten) alloy, a WMo (tungsten-molybdenum) alloy and a metal consisting primarily of one of these materials.

The material at least partially includes an hcp structure is preferably at least an alloy containing Co (cobalt) as the main component, for example at least one of a CoPt (cobalt-platinum) alloy, a CoCrPt (cobalt-chrome-platinum) alloy, and a CoCrTa (cobalt-chrome-tantalum) alloy.

The MR multilayered structure is preferably a TMR multilayered structure or a GMR multilayered structure having a CPP structure.

The present invention also provides a thin-film magnetic head including the MR element described above.

The present invention also provides a method for manufacturing a MR element which uses electric current in a direction perpendicular to layer planes, and the method includes the steps of forming an MR multilayered structure on a lower electrode layer, forming a magnetic domain controlling bias layer at least partially including an hcp structure on both sides of the MR multilayered structure along the track-width direction, forming a first metal layer of a material having a bcc structure on the magnetic domain controlling bias layer, forming a second metal layer of a material having a bcc structure on the first metal layer and the MR multilayered structure to contiguously cover the first metal layer and the MR multilayered structure, and forming an upper electrode layer on the second metal layer.

The present invention also provides a method for manufacturing an MR element which uses electric current in a direction perpendicular to layer planes, and the method includes the steps of forming an MR multilayered structure on a lower electrode layer, forming a magnetic domain controlling bias layer at least partially including an hcp structure on both sides of the MR multilayered structure along the track-width direction, forming a first metal layer of a material having a bcc structure on the magnetic domain controlling bias layer, planarizing the surface of the first metal layer and the MR multilayered structure to remove at least a portion of the first metal layer, forming a second metal layer of a material having a bcc structure on the planarized surface to contiguously cover the first metal layer or the magnetic domain controlling bias layer, and the MR multilayered structure, and forming an upper electrode layer on the second metal layer.

The first metal layer is formed of a material including a bcc structure on the magnetic domain controlling bias layer at least partially including an hcp structure. The second metal layer is formed of a material having a bcc structure on the first metal layer and the MR multilayered structure to contiguously cover them. Alternatively, the magnetic domain controlling bias layer at least partially including an hcp structure is formed, the first metal layer of a material having a bcc structure is formed on the magnetic domain controlling bias layer, the surface of the first metal layer and the MR multilayered structure is planarized to remove at least a portion of the first metal layer. The second metal layer of a material having a bcc structure is formed on the planarized surface to contiguously cover the first metal layer or the magnetic domain controlling bias layer and the MR multilayered structure. Thus, a sufficiently thick first and/or second metal layer of a material having a bcc structure is present on the end portion of the magnetic domain controlling bias layer that is near the MR multilayered structure and therefore especially the crystallinity of that portion of the magnetic domain controlling bias layer can be sufficiently improved. Consequently, the c-axis which is the axis of easy magnetization of the magnetic domain controlling bias layer can be directed to the in-plane direction of the MR multilayered structure to provide a sufficient bias magnetic field to the free layer of the MR multilayered structure. Thus, degradation of the MR read head element which would otherwise be caused by a mechanical strain resulting from thermal expansion, a stress by impact, or magnetostriction can be effectively prevented.

The first and second metal layers are preferably formed of the same material having a bcc structure.

Also preferably, an insulation layer is formed on the lower electrode layer and the side surface of the MR multilayered structure, an under layer of a material having a bcc structure is formed on the insulation layer, and the magnetic domain controlling bias layers is formed on the under layer. In this case, the under layer and the first and second metal layers are more preferably formed of the same material having a bcc structure.

The present invention also provides a method for manufacturing an MR element which uses electric current in a direction perpendicular to layer planes, and the method includes the steps of forming an MR multilayered structure on a lower electrode layer, forming a magnetic domain controlling bias layer at least partially including an hcp structure on both sides of the MR multilayered structure, forming a single metal layer of a material having a bcc structure on the magnetic domain controlling bias layer and the MR multilayered structure to cover the magnetic domain controlling bias layer and the MR multilayered structure, and forming an upper electrode layer on the single metal layer.

The magnetic domain controlling bias layer at least partially including an hcp structure is formed, and the single metal layer is formed of a material having a bcc structure on the magnetic domain controlling bias layer and the MR multilayered structure to cover them. Accordingly, a sufficiently thick metal layer of a material having the bcc is present on the end portion of the magnetic domain controlling bias layer that is near the MR multilayered structure and therefore especially the crystallinity of that portion of the magnetic domain controlling bias layer can be sufficiently improved. Consequently, the c-axis which is the axis of easy magnetization of the magnetic domain controlling bias layer can be directed to the in-plane direction of the MR multilayered structure to provide a sufficient bias magnetic field to the free layer of the MR multilayered structure. Thus, degradation of the MR read head element which would otherwise be caused by a mechanical strain resulting from thermal expansion, a stress by impact, or magnetostriction can be effectively prevented.

Preferably, an insulation layer is formed on the lower electrode layer and the side surface of the MR multilayered structure, an under layer of a material having a bcc structure is formed on the insulation layer, and the magnetic domain controlling bias layer is formed on the under layer. In this case, the under layer and the metal layer are more preferably formed of the same material having a bcc structure.

After the step of forming the upper electrode layer, preferably high-temperature annealing is performed at a predetermined temperature or higher.

The MR multilayered structure is preferably formed by forming an MR multilayered film on the lower electrode layer and performing milling through a mask formed on the MR multilayered film.

After the film for the magnetic domain controlling bias layer is formed through the mask, the mask is preferably lifted off to form the magnetic domain controlling bias layer.

The material having a bcc structure is preferably at least one of Cr, W, Ti, Mo, a CrTi alloy, a TiW alloy, a WMo alloy and a metal including primarily of one of these materials.

The material at least partially including an hcp structure is preferably an alloy primarily containing Co, for example at least one of a CoPt (cobalt-platinum) alloy, a CoCrPt (cobalt-chrome-platinum) alloy, and a CoCrTa (cobalt-chrome-tantalum) alloy.

The MR multilayered film formed is preferably a TMR multilayered film or a GMR multilayered film with a CPP structure.

The present invention also provides a method for manufacturing a thin-film magnetic head in which a magnetic read head element is fabricated by using any of the manufacturing methods described above.

### BRIEF DESCRIPTION OF THE DRAWINGS

FIG. 1 is a flowchart illustrating a process for manufacturing a thin-film magnetic head according to an embodiment of the present invention;

FIG. 2 is a cross-sectional view schematically showing a configuration of the thin-film magnetic head manufactured according to the embodiment shown in FIG. 1;

FIG. 3 is a flowchart illustrating in detail a process for manufacturing a read head element in the manufacturing process shown in FIG. 1;

FIGS. 4a to 4c are cross-sectional views illustrating the manufacturing process shown in FIG. 3;

FIG. 5 is a characteristics chart showing the results of actual measurements of the influence of the thickness of a Cr layer having a bcc structure on the magnetic coercive force of a magnetic domain controlling bias layer;

FIG. 6 is a flowchart illustrating in detail a process for manufacturing a read head element in a manufacturing process according to another embodiment of the present invention;

FIGS. 7a to 7d are cross-sectional views illustrating the manufacturing process shown in FIG. 6;

FIG. 8 is a flowchart illustrating in details a process for manufacturing a read head element in a manufacturing process according to still another embodiment of the present invention; and

FIGS. 9a to 9c are cross-sectional views illustrating the manufacturing process shown in FIG. 8.

### DESCRIPTION OF THE PREFERRED EMBODIMENTS

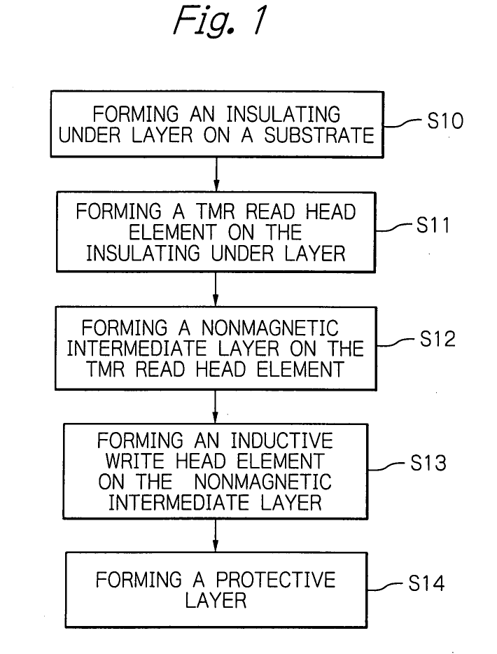

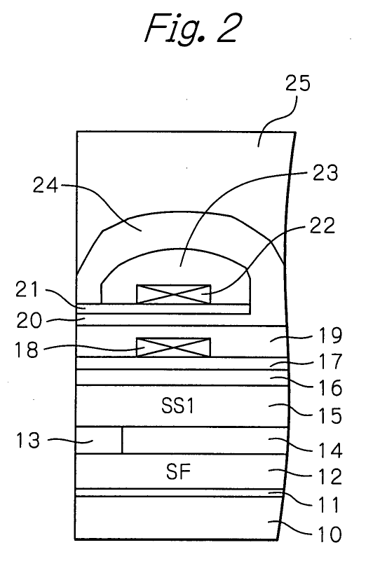

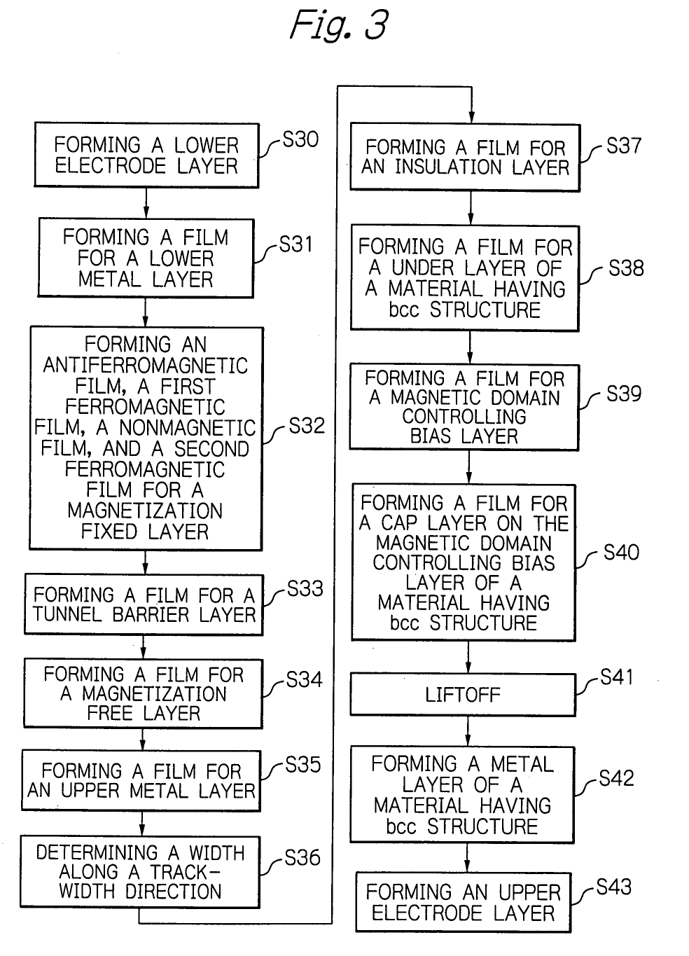

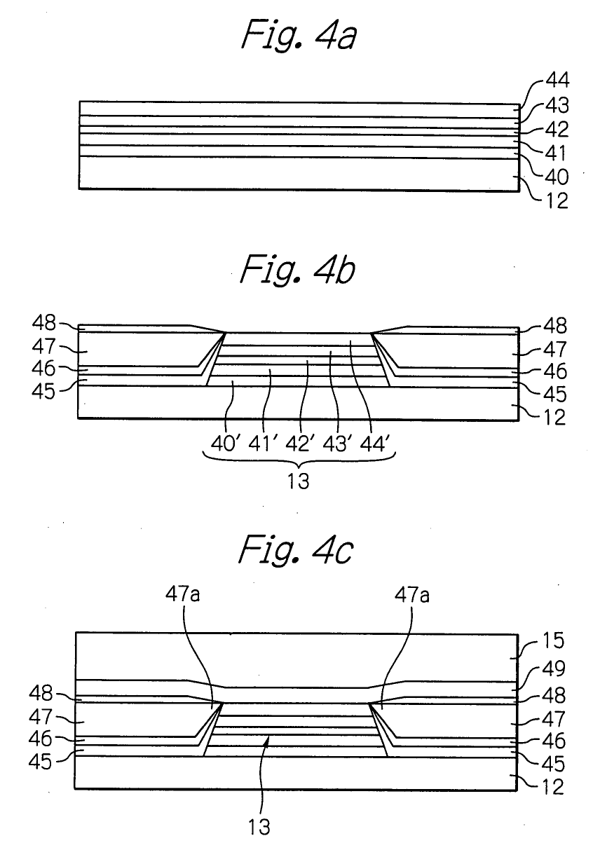

FIG. 1 is a flowchart illustrating a process for manufacturing a thin-film magnetic head according to an embodiment of the present invention, FIG. 2 is a cross-sectional view schematically showing a configuration of the thin-film magnetic head manufactured according to the embodiment shown in FIG. 1, FIG. 3 is a flowchart illustrating in detail a process for manufacturing a read head element in the manufacturing process shown in FIG. 1, and FIGS. 4a to 4c are cross-sectional views illustrating the manufacturing process shown in FIG. 3. The cross-section shown in FIG. 2 is a plane perpendicular to the ABS and the track-width direction of the thin-film magnetic head, and the cross-sections in FIGS. 4a to 4c are parallel to the ABS of the thin-film magnetic head.

While the magnetic head manufactured in this embodiment is a TMR thin-film magnetic head, a GMR thin-film magnetic head having the CPP structure can be manufactured as well using basically the same manufacturing process, except that a nonmagnetic conductor layer is formed in place of a tunnel barrier layer.

As shown in FIGS. 1 and 2, first a substrate or wafer 10 made of electrically conductive material such as AlTiC or Al₂O₃-TiC is provided. An insulating under layer 11 of an insulating material such as alumina (Al₂O₃) or silicon oxide (SiO₂) is formed on the substrate 10 to have a thickness between approximately 0.05 μm and approximately 10 μm by a method such as sputtering, in step S10.

Then, on the insulating under layer 11, a TMR read head element is formed that includes a lower electrode layer 12, which also acts as a lower shield layer (SF), a TMR multilayered structure 13, an insulation layer 14, a magnetic domain controlling bias layer 47 shown in FIGS. 4b and 4c, and an upper electrode layer 15, which also acts as an upper shield layer (SS1), in step S11. The detail of the process for manufacturing the TMR read head element is described later.

A nonmagnetic intermediate layer 16 is then formed on the TMR read head element in step S12. The nonmagnetic intermediate layer 16 may be formed of an insulating material such as Al₂O₃, SiO₂, aluminum nitride (AlN), or diamond-like carbon (DLC) or a metal material such as titanium (Ti), tantalum (Ta) or platinum (Pt) to have a thickness between approximately 0.1 μm and approximately 0.5 μm by using a method such as sputtering or chemical vapor deposition (CVD). The nonmagnetic intermediate layer 16 isolates the TMR read head element from an inductive write head element formed on it.

Then, on the nonmagnetic intermediate layer 16, the inductive write head element is formed that includes an insulation layer 17, a backing coil layer 18, a backing coil insulation layer 19, a main magnetic pole layer 20, an insulation gap layer 21, a write coil layer 22, a write coil insulation layer 23, and an auxiliary magnetic pole layer 24 in step S13. The inductive write head element in this embodiment has a perpendicular magnetic recording structure. However, it will be apparent that an inductive write head element having a longitudinal magnetic recording structure can be used. It will be also apparent that the perpendicular magnetic recording structure of the inductive write head element is not limited to the structure shown in FIG. 2 but instead any of various other structures can also be used.

The insulation layer 17 can be formed by depositing an insulating material such as Al₂O₃ or SiO₂ on the nonmagnetic intermediate layer 16 by using sputtering, for example. The upper surface of the insulation layer 17 is planarized by CMP, for example, as required. Formed on the insulation layer 17 is the baking coil layer 18 of a conducting material such as copper Cu by using a method such as frame plating to have a thickness between approximately 1 μm and approximately 5 μm. The purpose of the backing coil layer 18 is to guide a write magnetic flux so as to prevent adjacent track erasure (ATE). The backing coil insulation layer 19 is formed of a resist such as a thermoset novolac-type resist to have a thickness between approximately 0.5 μm to approximately 7 μm by a photolithography, for example, in such a manner that it covers the backing coil layer 18.

The main magnetic pole layer 20 is formed on the backing coil insulation layer 19. The main magnetic pole layer 20 acts as a magnetic path for converging and guiding a magnetic flux generated by the write coil layer 22 to a perpendicular magnetic recording layer of a magnetic disk on which data is to be written. The main magnetic pole layer 20 is formed of a metal magnetic material such as FeAlSi, NiFe, CoFe, NiFeCo, FeN, FeZrN, FeTaN, CoZrNb, or CoZrTa or a multilayered film including any of these materials to have a thickness between approximately 0.5 μm and approximately 3 μm by a method such as frame plating.

The insulation gap layer 21 is formed on the main magnetic pole layer 20 by depositing an insulating film of a material such as Al₂O₃ or SiO₂ by using a method such as sputtering. Formed on the insulation gap layer 21 is the write coil insulation layer 23 of a thermoset novolac-type resist, for example, with a thickness between approximately 0.5 μm and approximately 7 μm. The write coil layer 22 of a conducting material such as Cu with a thickness of approximately 1 to 5 μm is formed inside the write coil insulation layer 23 by a method such as frame plating. To thermoset the write coil insulation layer 23, annealing is always performed at a high temperature in the range from approximately 200° C. to approximately 250° C., for example.

The auxiliary magnetic pole layer 24 of a metal magnetic material such as FeAlSi, NiFe, CoFe, NiFeCo, FeN, FeZrN, FeTaN, CoZrNb, or CoZrTa or a multilayered film of any of these materials with a thickness between approximately 0.5 μm and approximately 3 μm is formed by a method such as frame plating so as to cover the write coil insulation layer 23. The auxiliary magnetic pole layer 24 forms a return yoke.

Then, a protective layer 25 is formed on the inductive write head element in step S14. The protective layer 25 may be formed by depositing a material such as Al₂O₃ or SiO₂ using sputtering, for example.

This completes the wafer process for the thin-film magnetic head. The subsequent processes for manufacturing the thin-film magnetic head such as a fabrication process are well known and therefore the description of which will be omitted.

The detail of manufacturing process of the TMR read head element is described below with reference to FIGS. 3 and 4a through 4c.

First, the lower electrode layer 12, which also acts as a lower shield layer, is formed on the insulating under layer 11 shown in FIG. 2, in step S30. The lower electrode layer 12 is formed of a metal magnetic material such as FeAlSi, NiFe, CoFe, FeNiCo, FeN, FeZrN, FeTaN, CoZrNb, or CoZrTa to have a thickness between approximately 0.1 μm and approximately 3 μm by a method such as frame plating.

Then, on the lower electrode layer 12, a film 40 for a lower metal layers is formed that consists of a film of a material such as Ta, chrome (Cr), hafnium (Hf), niobium (Nb), zirconium (Zr), Ti, molybdenum (Mo), or tungsten (W) having a thickness between approximately 0.5 nm to approximately 5 nm and a film of a material such as NiCr, NiFe, NiFeCr, ruthenium (Ru), cobalt (Co), or CoFe having a thickness between approximately 1 nm and approximately 6 nm by a method such as sputtering in step S31.

A film 41 for a magnetization fixed layer is deposited on the film 40 in step S32. The film 41 for the magnetization fixed layer in this embodiment is of synthetic type, formed by depositing by sputtering an antiferromagnetic film for a pin layer of a material such as IrMn, PtMn, NiMn, or RuRhMn with a thickness between approximately 5 nm and approximately 30 nm, a first ferromagnetic film of a material such as CoFe with a thickness between approximately 1 nm and approximately 5 nm, a nonmagnetic film of an alloy of one or more of materials such as ruthenium (Ru), rhodium (Rh), iridium (Ir), chromium (Cr), rhenium (Re), and copper (Cu) with a thickness of approximately 0.8 nm, and a second ferromagnetic film of a material such as CoFe, CoFeSi, CoMnGe, CoMnSi, or CoMnAl with a thickness between approximately 1 nm and approximately 3 nm, in this order.

Then, a film 42 for a tunnel barrier layer of an oxide of an aluminum (Al), titanium (Ti), Ta, Zr, Hf, magnesium (Mg), silicon (Si), or zinc (Zn) with a thickness of approximately 0.5 nm to 1 nm is deposited on the film 41 for the magnetization fixed layer in step S33.

A film 43 for a magnetization free layer is formed on the film 42 for tunnel barrier layer by depositing a high-polarizability film of a material such as CoFe, CoFeSi, CoMnGe, CoMnSi, or CoMnAl with a thickness of approximately 1 nm and a soft magnetic film of a material such as NiFe with a thickness between approximately 1 nm and approximately 9 nm, in this order, by sputtering in step S34.

Then, a film 44 for an upper metal layer consisting of one or more layers of a nonmagnetic conducting material such as Ta, Ru, Hf, Nb, Zr, Ti, Cr, or W with a thickness between approximately 1 nm and 10 nm is deposited by a method such as sputtering in step S35. FIG. 4a shows the layers formed as a result of the steps described thus far.

In step S36, patterning is performed for defining the width in the track-width direction of the TMR multilayered film thus formed. First, a mask which is not shown in figures having a resist pattern for liftoff is formed on the TMR multilayered film. The mask is used to perform ion milling, for example ion beam etching using Ar ions. As a result of the milling, the TMR multilayered structure 13 having multiple layers including a lower metal layer 40′, a magnetization fixed layer 41′, a tunnel barrier layer 42′, a free layer 43′, and an upper metal layer 44′, starting from the bottom, can be obtained as shown in FIG. 4b.

A film for an insulation layer of an insulating material such as Al₂O₃ or SiO₂ is deposited on it to have a thickness between approximately 3 nm and approximately 20 nm by a method such as sputtering or IBD (Ion Beam Deposition) in step S37. A film for an under layer of a material having a bcc structure, for example Cr, is deposited on the film for the insulation layer to have a thickness of approximately 5 nm by using a method such as sputtering or IBD in step S38, and a film for a magnetic domain controlling bias layer of a Co-based material, for example a CoPt alloy, that at least partially includes an hcp structure is further deposited on the film for the under layer to have a thickness between approximately 10 nm and approximately 40 nm by a method such as sputtering or IBD in step S39. A film of a material having a bcc structure such as Cr for a cap layer on the magnetic domain controlling bias layer is deposited on the film for the magnetic domain controlling bias layer to have a thickness between approximately 1 nm and approximately 2 nm by using a method such as sputtering or IBD in step S40. The thickness of the film for the under layer is preferably 2 nm or more in order to obtain a sufficient magnetic coercive force, which will be described later. However, the thickness is preferably approximately 10 nm at the maximum because the flatness of the film not subjected to CMP decreases if the film is too thick. That is, the thickness of the film for the under layer is preferably in the range between approximately 2 nm and 10 nm. Since planarization by CMP is not performed in the present embodiment for the cap layer on the magnetic domain controlling bias layer, a thickness of at least 1 nm to 2 nm is required for the cap layer in order to prevent corrosion and oxidization during the wafer process for the magnetic domain controlling bias layer. If the film for the cap layer on the magnetic domain controlling bias layer is thicker, the flatness of the film decreases because CMP is not performed.

Then, the mask is removed to liftoff in step S41. FIG. 4b shows this state. An insulation layer 45, an under layer 46, the magnetic domain controlling bias layer 47, and a cap layer 48 on the magnetic domain controlling bias layer, which is also referred as a first metal layer in the present invention, are formed on the sides of the TMR multilayered structure 13 and on the lower electrode layer 12.

A metal layer 49, which is also referred as a second metal layer in the present invention, of a material having a bcc structure, for example Cr, is formed on the TMR multilayered structure 13 and the cap layer 48 on the magnetic domain controlling bias layer to have a thickness of approximately 10 nm by a method such as sputtering in such a manner that the metal layer 49 contiguously cover the TMR multilayered structure 13 and the cap layer 48 on the magnetic domain controlling bias layer in step S42.

Then, an upper electrode layer 15, which also acts as an upper shield layer, is formed on the metal layer 49 in step S43. The upper electrode layer 15 may be formed by flame-plating with a metal magnetic material such as FeAlSi, NiFe, CoFe, FeNiCo, FeN, FeZrN, FeTaN, CoZrNb, or CoZrTa to have a thickness between approximately 0.1 μm and approximately 3 μm. FIG. 4c shows this state.

The material having a bcc structure is not limited to Cr, and it may be W, Ti, Mo, a CrTi alloy, a TiW alloy, a WMo alloy or a metal containing any of these as the main component. The material of the magnetic domain controlling bias layer having an hcp structure may be a CoPt alloy, a CoCrPt alloy, or a CoCrTa alloy.

The films of the magnetization fixed layer, the barrier layer, and the magnetization free layer that constitute the magneto-sensitive portion of the TMR multilayered structure 13 are not limited to the embodiment described above. Various materials and thicknesses may be used. For example, the magnetization fixed layer is not limited to the three-layered structure consisting of three films in addition to the antiferromagnetic film. The magnetization fixed layer may have a single-layer structure made of a ferromagnetic film or a multilayered structure consisting of more or less than three layers. The magnetization free layer is not limited to the two-layered structure. It may have a single-layer structure without the high-polarizability film or a multilayered structure of three or more layers including a magnetostriction controlling film.

Furthermore, the magnetization fixed layer, barrier layer, and magnetization free layer of the magneto-sensitive portion may be formed in the inverse order, that is, in the order of the magnetization free layer, the barrier layer, and the magnetization fixed layer. In that case, the antiferromagnetic film in the magnetization fixed layer is positioned at the top.

According to this embodiment, the metal layer 49 of a material having a bcc structure is formed on the magnetic domain controlling bias layer 47 of a material at least partially including an hcp structure and on the MR multilayered structure 13 in such a manner that the metal layer 49 contiguously covers them, as described above. Thus, a sufficiently thick-metal layer 49 of the material having the bcc structure is present on the end portion 47a of the magnetic domain controlling bias layer 47 near the TMR multilayered structure 13 as shown in FIG. 4c.

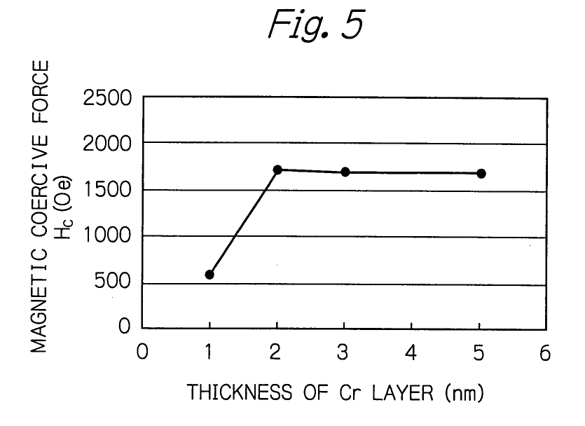

FIG. 5 shows a characteristics chart showing the results of actual measurements of the influence of the thickness of a Cr layer having a bcc structure on the magnetic coercive force (Hc) of a magnetic domain controlling bias layer that is a CoPt layer at least partially including an hcp structure.

Samples were formed each of which consisted of a Cr layer having a different thickness (1 nm, 2 nm, 3 nm, and 5 nm), a CoPt layer (25 nm thick), and a Ta layer (5 nm thick) formed on a substrate and the magnetic coercive force (Oe) of the CoPt layer was measured with a vibration sample magnetometer (VSM).

It can be seen from the chart that a sufficient magnetic coercive force can be achieved when the thickness of the Cr layer formed in contact with the CoPt layer is 2 nm or more.

According to this embodiment, the cap layer 48 on the magnetic domain controlling bias layer is formed by a Cr layer with a thickness of approximately 5 nm and the metal layer 49 is formed by a Cr layer with a uniform thickness of approximately 10 nm, therefore especially the crystallinity of the end portion 47a of the magnetic domain controlling bias layer 47 can be sufficiently increased to provide sufficiently high magnetic coercive force. Accordingly, the c-axis which is the axis of easy magnetization of the magnetic domain controlling bias layer 47 can be directed to the in-plane direction of the TMR multilayered structure 13 to provide a sufficient bias magnetic field to its free layer 43′. Consequently, degradation of the TMR read head element which would otherwise be caused by a mechanical strain resulting from thermal expansion, a stress by impact, or magnetostriction can be effectively prevented.

Tolerance test has been conducted on 50 samples that use Ta layers for both the cap layer 48 and the metal layer 49, and conducted on 50 samples that use Cr layers for both the cap layer 48 and the metal layer 49. In the testing, a write stress was applied to the samples. First, an output (Amp 1) from the TMR read head element was measured with a QST (Quasi-Static Tester), and then a quasi write stress is applied to the samples and an output (Amp 2) from the TMR read head element was measured with the QST. Then dAmp % was calculated as dAmp %=(Amp 1−Amp 2)/Amp 1×100. A write current of 59 mA (maximum) at a frequency of 374 MHz, which is a quasi write stress stronger than stresses that are applied under normal HDD use conditions, was applied for four minutes in the absence of a magnetic medium. The testing showed that 7.40% of the samples using the Ta layers exceeded a dAmp % of 30% whereas 2.50% of the samples using the Cr layers exceeded dAmp % of 30%. Thus, it was shown that the tolerance to write stress is significantly improved by using the Cr layer.

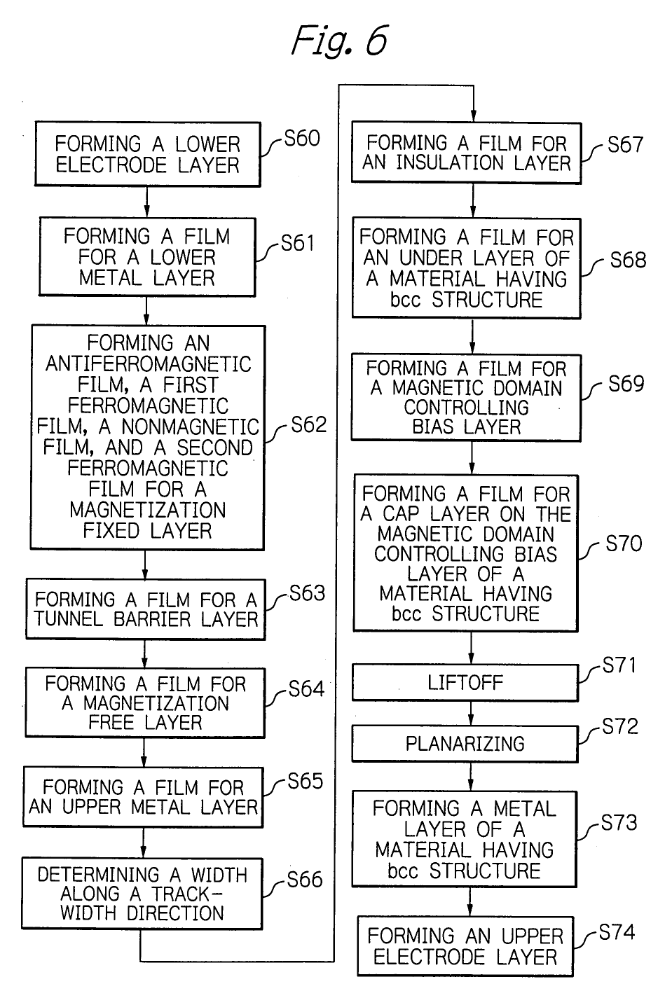

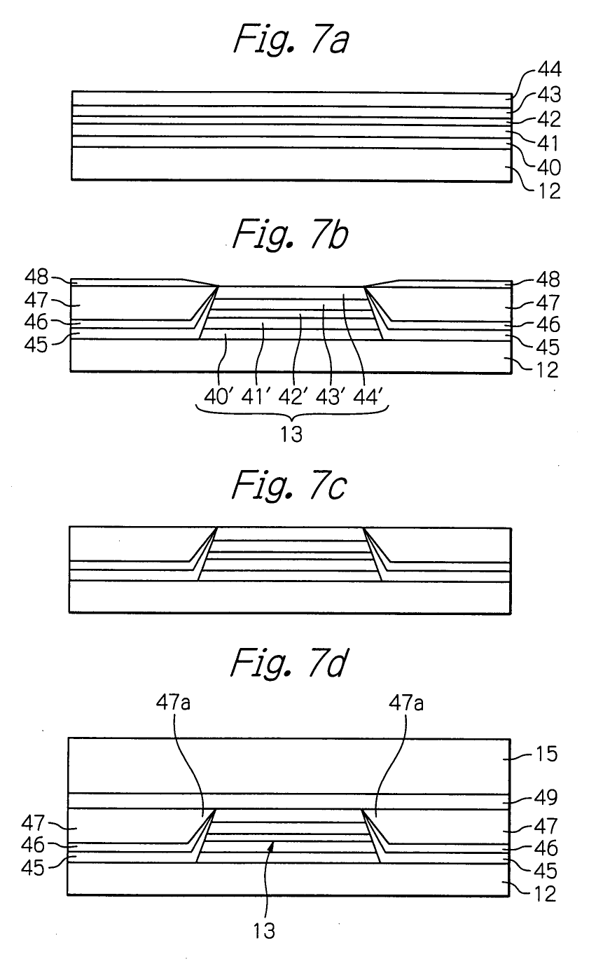

FIG. 6 shows a flowchart illustrating in detail a process for manufacturing a read head element in a manufacturing process according to another embodiment of the present invention. FIGS. 7a to 7d are cross-sectional views illustrating the manufacturing process shown in FIG. 6. FIGS. 7a to 7d show cross-sections parallel to the ABS of a thin-film magnetic head.

While the magnetic head manufactured in this embodiment is a TMR thin-film magnetic head, a GMR thin-film magnetic head having the CPP structure can be manufactured as well using basically the same manufacturing process, except that a nonmagnetic conductor layer is formed in place of a tunnel barrier layer.

The thin-film magnetic head manufacturing process according to this embodiment is the same as the process shown in FIGS. 1 and 2, except the process for manufacturing the TMR read head element. Therefore, description of the same process will be omitted and the same components as those in the embodiment shown in FIG. 1 will be labeled the same reference numerals.

The process for manufacturing the TMR read head element will be described in detail below with reference to FIGS. 6 and 7a to 7d.

First, a lower electrode layer 12, which also acts as a lower shield layer, is formed on an insulating under layer 11 as shown in FIG. 2, in step S60. The lower electrode layer 12 may be formed of a metal magnetic material such as FeAlSi, NiFe, CoFe, FeNiCo, FeN, FeZrN, FeTaN, CoZrNb, or CoZrTa to have a thickness between approximately 0.1 μm and approximately 3 μm by a method such as frame plating.

Then, on the lower electrode layer 12, a film 40 for a lower metal layer is formed that includes a film of a material such as Ta, chrome (Cr), hafnium (Hf), niobium (Nb), zirconium (Zr), Ti, molybdenum (Mo), or tungsten (W) having a thickness between approximately 0.5 nm and approximately 5 nm and a film of a material such as NiCr, NiFe, NiFeCr, ruthenium (Ru), cobalt (Co), or CoFe having a thickness between approximately 1 nm and approximately 6 nm by a method such as sputtering in step S61.

A film 41 for a magnetization fixed layer is deposited on the film 40 in step S62. The film 41 for the magnetization fixed layer in this embodiment is of synthetic type, formed by depositing by sputtering an antiferromagnetic film for a pin layer of a material such as IrMn, PtMn, NiMn, or RuRhMn with a thickness between approximately 5 nm and approximately 30 nm, a first ferromagnetic film of a material such as CoFe with a thickness between approximately 1 nm and approximately 5 nm, a nonmagnetic film of an alloy of one or more of materials such as ruthenium (Ru), rhodium (Rh), iridium (Ir), chromium (Cr), rhenium (Re), and copper (Cu) with a thickness of approximately 0.8 nm, and a second ferromagnetic film of a material such as CoFe, CoFeSi, CoMnGe, CoMnSi, or CoMnAl with a thickness between approximately 1 nm and approximately 3 nm, in this order.

Then, a film 42 for a tunnel barrier layer of an oxide of an aluminum (Al), titanium (Ti), Ta, Zr, Hf, magnesium (Mg), silicon (Si), or zinc (Zn) with a thickness between approximately 0.5 nm and approximately 1 nm is deposited on the film 41 for the magnetization fixed layer in step S63.

A film 43 for a magnetization free layer is formed on the film 42 for the tunnel barrier layer by depositing a high-polarizability film of a material such as CoFe, CoFeSi, CoMnGe, CoMnSi, or CoMnAl with a thickness of approximately 1 nm and a soft magnetic film of a material such as NiFe with a thickness between approximately 1 nm and approximately 9 nm, in this order, by sputtering, for example in step S64.

Then, a film 44 for an upper metal layer consisting of one or more layers of a nonmagnetic conducting material such as Ta, Ru, Hf, Nb, Zr, Ti, Cr, or W with a thickness between approximately 1 nm and approximately 10 nm is deposited by a method such as sputtering in step S65. FIG. 7a shows the layers formed as a result of the steps described thus far.

In step S66, patterning is performed for defining the width in the track-width direction of the TMR multilayered film thus formed. First, a mask (not shown) having a resist pattern for liftoff is formed on the TMR multilayered film. The mask is used to perform ion milling, for example ion beam etching using Ar ions. As a result of the milling, a TMR multilayered structure 13 having multiple layers including a lower metal layer 40′, a magnetization fixed layer 41′, a tunnel barrier layer 42′, a free layer 43′, and an upper metal layer 44′, starting from the bottom, can be obtained as shown in FIG. 7b.

A film for an insulation layer of an insulating material such as Al₂O₃ or SiO₂ is deposited on it to have a thickness of approximately 3 nm to approximately 20 nm by a method such as sputtering or IBD (Ion Beam Deposition) in step S67. A film for an under layer of a material having a bcc structure, for example Cr, is deposited on the film by using a method such as sputtering or IBD in step S68, and a film for a magnetic domain controlling bias layer of a Co-based material, for example a CoPt alloy, that at least partially includes an hcp structure is further deposited on it to have a thickness of approximately 10 nm to 40 nm by a method such as sputtering or IBD in step S69. A film for a cap layer on the magnetic domain controlling bias layer of a material having a bcc structure such as Cr is deposited on it to have a thickness of approximately 5 nm by using a method such as sputtering or IBD in step S70. The thickness of the film for the under layer is preferably 2 nm or more in order to obtain sufficient magnetic coercive force, as already described. However, the thickness is preferably approximately 10 nm at the maximum because the flatness of the film not subjected to CMP decreases if the film is too thick. That is, the thickness of the film for the under layer is preferably between approximately 2 nm and approximately 10 nm. If planarization by CMP is performed as in the present embodiment, a desired thickness can be achieved for the cap layer on the magnetic domain controlling bias layer, and a thickness of at least 1 nm to 2 nm for the cap layer suffices in order to prevent corrosion and oxidization during the wafer process for the magnetic domain controlling bias layer.

Then, the mask is removed by liftoff in step S71. FIG. 7b shows this state. An insulation layer 45, an under layer 46, a magnetic domain controlling bias layer 47, and a cap layer 48 on the magnetic domain controlling bias layer are formed on the sides of the TMR multilayered structure 13 and on the lower electrode layer 12.

The upper surface is planarized by a method such as chemical mechanical polishing (CMP) in step S72. The planarization removes a portion of or the entire cap layer 48 on the magnetic domain controlling bias layer, and a portion of the magnetic domain controlling bias layer 47 may be removed. FIG. 7c shows the state after the planarization. The surface may be planarized together with the mask by using CMP without performing liftoff at step S71.

Then, a metal layer 49 of a material having a bcc structure, for example Cr, is formed on the TMR multilayered structure 13 and the magnetic domain controlling bias layer 47, or on the TMR multilayered structure 13, a portion of the cap layer 48 on the magnetic domain controlling bias layer and the magnetic domain controlling bias layer 47 to have a thickness of approximately 10 nm by sputtering in such a manner that the metal layer 49 contiguously covers them in step S73.

Then an upper electrode layer 15, which also acts as an upper shield layer, is formed on the metal layer 49 in step S74. The upper electrode layer 15 may be formed of a metal magnetic material such as FeAlSi, NiFe, CoFe, FeNiCo, FeN, FeZrN, FeTaN, CoZrNb, or CoZrTa to have a thickness between approximately 0.1 μm and approximately 3 μm by a method such as frame plating. FIG. 7d shows this state.

The material having a bcc structure is not limited to Cr, and it may be W, Ti, Mo, a CrTi alloy, a TiW alloy or a WMo alloy or a metal containing any of these as the main component. The material of the magnetic domain controlling bias layer having an hcp structure may be CoPt, a CoCrPt alloy, or a CoCrTa alloy.

The films of the magnetization fixed layer, the barrier layer, and the magnetization free layer that constitute the magneto-sensitive portion of the TMR multilayered structure 13 are not limited to the embodiment described above. Various materials and thicknesses may be used. For example, the magnetization fixed layer is not limited to the three-layered structure consisting of three films in addition to the antiferromagnetic film. The magnetization fixed layer may have a single-layer structure made of a ferromagnetic film or a multilayered structure consisting of more or less than three layers. The magnetization free layer is not limited to the two-layered structure. It may have a single-layer structure without the high-polarizability film or a multilayered structure of three or more layers including a magnetostriction controlling film.

Furthermore, the magnetization fixed layer, barrier layer, and magnetization free layer of the magneto-sensitive portion may be formed in the inverse order, that is, in the order of the magnetization free layer, the barrier layer, and the magnetization fixed layer. In that case, the antiferromagnetic film in the magnetization fixed layer is positioned at the top.

According to this embodiment, the metal layer 49 of a material having a bcc structure is formed on the magnetic domain controlling bias layer 47 of a material at least partially including an hcp structure and on the MR multilayered structure 13 in such a manner that the metal layer 49 contiguously covers them, as described above. Thus, a sufficiently thick metal layer 49 of the material having the bcc structure is present on the end portion 47a of the magnetic domain controlling bias layer 47 near the TMR multilayered structure 13 as shown in FIG. 7d, and therefore especially the crystallinity of the portion 47a of the magnetic domain controlling bias layer 47 can be sufficiently increased to provide sufficiently high magnetic coercive force. Accordingly, the c-axis which is the axis of easy magnetization of the magnetic domain controlling bias layer 47 can be directed to the in-plane direction of the TMR multilayered structure 13 to provide a sufficient bias magnetic field to its free layer 43′. Consequently, degradation of the TMR read head element which would otherwise be caused by a mechanical strain resulting from thermal expansion, a stress by impact, or magnetostriction can be effectively prevented.

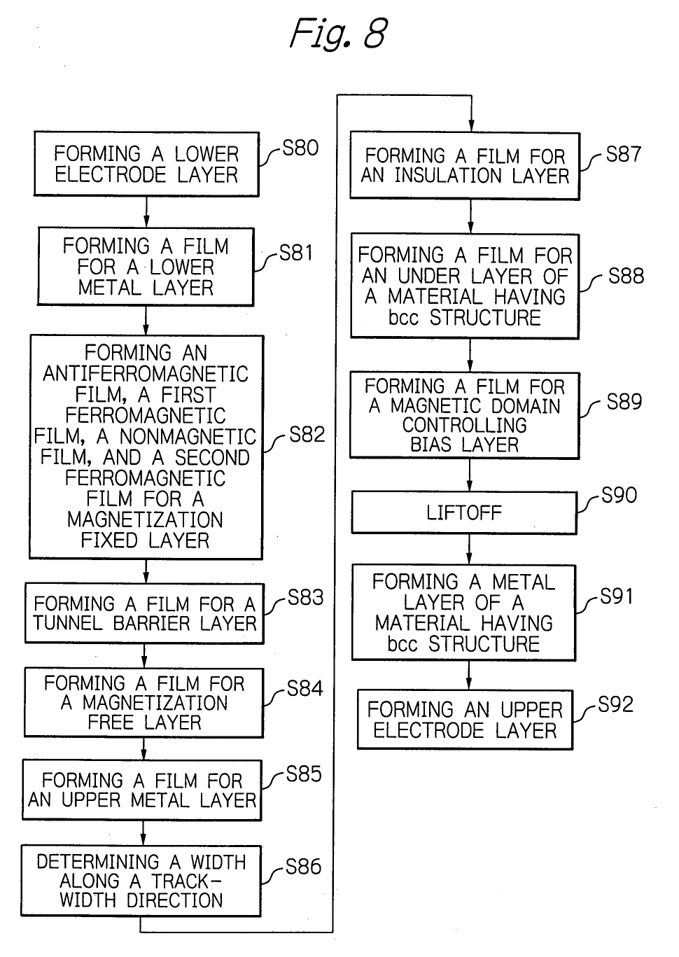

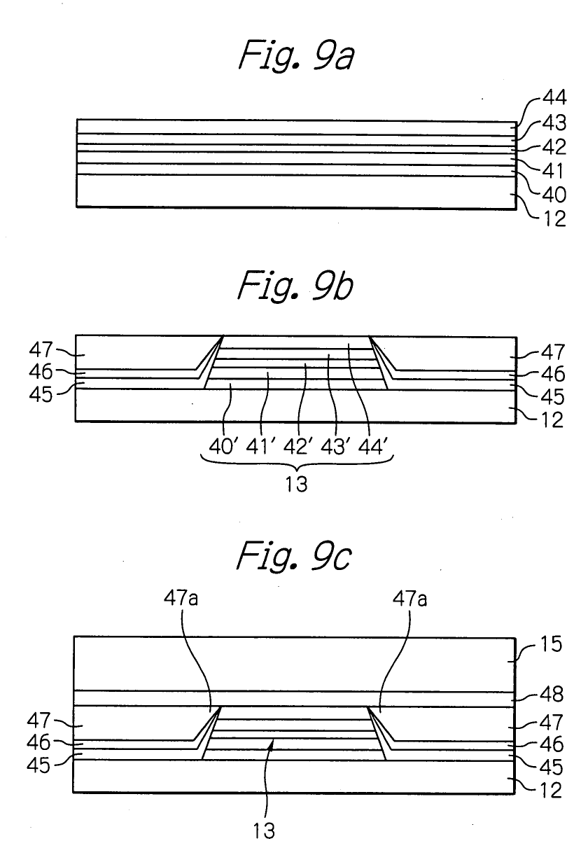

FIG. 8 is a flowchart illustrating in detail a process for manufacturing a read head element in a manufacturing process according to still another embodiment of the present invention. FIGS. 9a to 9c are cross-sectional views illustrating the manufacturing process shown in FIG. 8. FIGS. 9a to 9c show cross-sections parallel to the ABS of a thin-film magnetic head.

While the magnetic head manufactured in this embodiment is a TMR thin-film magnetic head, a GMR thin-film magnetic head having the CPP structure can be manufactured as well using basically the same manufacturing process, except that a nonmagnetic conductor layer is formed in place of a tunnel barrier layer.

The thin-film magnetic head manufacturing process according to this embodiment is the same as the process shown in FIGS. 1 and 2, except the process for manufacturing the TMR read head element. Therefore, description of the same process will be omitted and the components as those in the embodiment shown in FIG. 1 will be labeled the same reference numerals.

The process for manufacturing the TMR read head element is described-in detail below with reference to FIGS. 8 and 9a to 9c.

First, a lower electrode layer 12, which also acts as a lower shield layer, is formed on an insulating under layer 11 shown in FIG. 2, in step S80. The lower electrode layer 12 may be formed of a metal magnetic layer such as FeAlSi, NiFe, CoFe, FeNiCo, FeN, FeZrN, FeTaN, CoZrNb, or CoZrTa to have a thickness in the range from about 0.1 μm to about 3 μm by a method such as frame plating.

Then, on the lower electrode layer 12, a film 40 for a lower metal layers is formed by a method such as sputtering that includes a film of a material such as Ta, chrome (Cr), hafnium (Hf), niobium (Nb), zirconium (Zr), Ti, molybdenum (Mo), or tungsten (W) having a thickness between approximately 0.5 nm and approximately 5 nm and a film of a material such as NiCr, NiFe, NiFeCr, ruthenium (Ru), cobalt (Co), or CoFe having a thickness between approximately 1 nm and approximately 6 nm in step S81.

A film 41 for a magnetization fixed layer is deposited on the film 40 in step S82. The film 41 for the magnetization fixed layer in this embodiment is of synthetic type, formed by depositing by sputtering an antiferromagnetic film for a pin layer of a material such as IrMn, PtMn, NiMn, or RuRhMn with a thickness between approximately 5 nm and approximately 30 nm, a first ferromagnetic film of a material such as CoFe with a thickness between approximately 1 nm and approximately 5 nm, a nonmagnetic film of an alloy of one or more of materials such as ruthenium (Ru), rhodium (Rh), iridium (Ir), chromium (Cr), rhenium (Re), and copper (Cu) with a thickness of approximately 0.8 nm, and a second ferromagnetic film of a material such as CoFe, CoFeSi, CoMnGe, CoMnSi, or CoMnAl with a thickness between approximately 1 nm and 3 nm, in this order.

Then, a film 42 for a tunnel barrier layer of an oxide of an aluminum (Al), titanium (Ti), Ta, Zr, Hf, magnesium (Mg), silicon (Si), or zinc (Zn) with a thickness between approximately 0.5 nm and 1 nm is deposited on the film 41 for the magnetization fixed layer in step S83.

A film 43 for a magnetization free layer is formed on the film 42 for the tunnel barrier layer by depositing a high-polarizability film of a material such as CoFe, CoFeSi, CoMnGe, CoMnSi, or CoMnAl with a thickness of approximately 1 nm and a soft magnetic film of a material such as NiFe with a thickness between approximately 1 nm and approximately 9 nm in this order by sputtering in step S84.

Then, a film 44 for an upper metal layer consisting of one or more layers of a nonmagnetic conducting material such as Ta, Ru, Hf, Nb, Zr, Ti, Cr, or W with a thickness between approximately 1 nm and approximately 10 nm is deposited by a method such as sputtering in step S85. FIG. 9a shows the layers formed as a result of the steps described thus far.

In step S86, Patterning is performed for determining the width in the track-width direction of the TMR multilayered film thus formed. First, a mask (not shown) having a resist pattern for liftoff is formed on the TMR multilayered film. The mask is used to perform ion milling, for example ion beam etching using Ar ions. As a result of the milling, a TMR multilayered structure 13 having multiple layers including a lower metal layer 40′, a magnetization fixed layer 41′, a tunnel barrier layer 42′, a free layer 43′, and an upper metal layer 44′, starting from the bottom, can be obtained as shown in FIG. 9b.

A film for an insulation layer of an insulating material such as Al₂O₃ or Sib₂ is deposited on it to have a thickness between approximately 3 nm and approximately 20 nm by a method such as sputtering or IBD (Ion Beam Deposition) in step S87. A film for an under layer of a material having a bcc structure, for example Cr, is deposited on the film for an insulation layer to have a thickness of approximately 5 nm by using a method such as sputtering or IBD in step S88, and a film for a magnetic domain controlling bias layer of a Co-based material, for example a CoPt alloy, that at least partially includes an hcp structure is further deposited on the film for an under layer to have a thickness between approximately 10 nm and approximately 40 nm by a method such as sputtering or IBD in step S89. The thickness of the film for the under layer is preferably 2 nm or more in order to obtain sufficient magnetic coercive force as mentioned earlier. However, the thickness is preferably approximately 10 nm at the maximum because the flatness of the film not subjected to CMP decreases if the film is too thick. That is, the thickness of the film for the under layer is preferably in the range from approximately 2 nm to approximately 10 nm.

Then, the mask is removed by liftoff in step S90. FIG. 9b shows this state. An insulation layer 45, an under layer 46, a magnetic domain controlling bias layer 47 are formed on the sides of the TMR multilayered structure 13 and on the lower electrode layer 12.

Then, a metal layer 49 of a material having a bcc structure, for example Cr is formed on the TMR multilayered structure 13 and the magnetic domain controlling bias layer 47 to have a thickness of approximately 10 nm by sputtering in such a manner that the metal layer 49 contiguously covers them in step S91.

Then an upper electrode layer 15, which also acts as an upper shield layer, is formed on the metal layer 49 in step S92. The upper electrode layer 15 may be formed of a metal magnetic material such as FeAlSi, NiFe, CoFe, FeNiCo, FeN, FeZrN, FeTaN, CoZrNb, or CoZrTa to have a thickness between approximately 0.1 μm and approximately 3 μm by a method such as frame plating. FIG. 9c shows this state.

The material having a bcc is not limited to Cr, and it may be W, Ti, Mo, a CrTi alloy, a TiW alloy or a WMo alloy or a metal containing any of these as the main component. The material of the magnetic domain controlling bias layer having an hcp structure may be CoPt, a CoCrPt alloy, or a CoCrTa alloy.

The films of the magnetization fixed layer, the barrier layer, and the magnetization free layer that constitute the magneto-sensitive portion of the TMR multilayered structure 13 are not limited to the modes described above. Various materials and thicknesses may be used. For example, the magnetization fixed layer is not limited to the three-layered structure consisting of three films in addition to the antiferromagnetic film. The magnetization fixed layer may have a single-layer structure made of a ferromagnetic film or a multilayered structure consisting of more or less than three layers. The magnetization free layer is not limited to the two-layered structure. It may have a single-layer structure without the high-polarizability film or a multilayered structure of three or more layers including a magnetostriction controlling film. Furthermore, the magnetization fixed layer, barrier layer, and magnetization free layer of the magneto-sensitive portion may be formed in the inverse order, that is, in the order of the magnetization free layer, the barrier layer, and the magnetization fixed layer. In that case, the antiferromagnetic film in the magnetization fixed layer is positioned at the top.

According to this embodiment, the metal layer 49 of a material having a bcc structure is formed on the magnetic domain controlling bias layer 47 of a material that at least partially includes an hcp structure and the MR multilayered structure 13 in such a manner that the metal layer 49 contiguously covers them as described above. Thus, a sufficiently thick metal layer 49 of the material having the bcc is present on the end portion 47a of the magnetic domain controlling bias layer 47 near the TMR multilayered structure 13 shown in FIG. 9c, and therefore especially the crystallinity of that portion 47a of the magnetic domain controlling bias layer 47 can be sufficiently increased to provide sufficiently high magnetic coercive force. Accordingly, the c-axis which is the axis of easy magnetization of the magnetic domain controlling bias layer 47 can be directed to the in-plane direction of the TMR multilayered structure 13 to provide a sufficient bias magnetic field to its free layer 43′. Consequently, degradation of the TMR read head element which would otherwise be caused by a mechanical strain resulting from thermal expansion, a stress by impact, or magnetostriction can be effectively prevented.

It should be understood that the embodiments described above are illustrative only and not limitative. The present invention can be embodied in various other variations and modifications. Therefore, the scope of the present invention is defined only by the attached claims and their equivalents.

1. A magnetoresistive effect element using electric current in a direction perpendicular to layer planes, comprising:
a lower electrode layer;
a magnetoresistive effect multilayered structure formed on the lower electrode layer;
a magnetic domain controlling bias layer made of a material at least partially including a hexagonal close-packed structure formed on both sides of the magnetoresistive effect multilayered structure along the track-width direction;
a metal layer made of a material having a body-centered cubic lattice structure formed on the magnetic domain controlling bias layer and the magnetoresistive effect multilayered structure to contiguously cover the magnetic domain controlling bias layer and the magnetoresistive effect multilayered structure; and
an upper electrode layer formed on the metal layer.

2. The magnetoresistive effect element according to claim 1, wherein the metal layer is a single metal layer contiguously formed to cover the magnetic domain controlling bias layer and the magnetoresistive effect multilayered structure.

3. The magnetoresistive effect element according to claim 1, wherein the metal layer comprises a first metal layer formed only on the magnetic domain controlling bias layer and a second metal layer formed on the first metal layer and the magnetoresistive effect multilayered structure.

4. The magnetoresistive effect element according to claim 1, further comprising an under layer made of a material having a body-centered cubic lattice structure formed under the magnetic domain controlling bias layer.

5. The magnetoresistive effect element according to claim 4, further comprising an insulation layer formed under the under layer.

6. The magnetoresistive effect element according to claim 4, wherein the metal layer and the under layer are made of the same material having a body-centered cubic lattice structure.

7. The magnetoresistive effect element according to claim 1, wherein the material having a body-centered cubic lattice structure is at least one selected among Cr, W, Ti, Mo, a CrTi alloy, a TiW alloy, a WMo alloy and a metal mainly including Cr, W, Ti, Mo, a CrTi alloy, a TiW alloy, or a WMo alloy.

8. The magnetoresistive effect element according to claim 1, wherein the material at least partially including a hexagonal close-packed structure is an alloy mainly including Co.

9. The magnetoresistive effect element according to claim 1, wherein the magnetoresistive effect multilayered structure is a tunnel magnetoresistive effect multilayered structure or a giant-magnetoresistive effect multilayered structure having a current-perpendicular-to-plane structure.

10. A thin-film magnetic head comprising a magnetoresistive effect element, wherein the magnetoresistive effect element uses electric current in a direction perpendicular to layer planes and comprises:
a lower electrode layer;
a magnetoresistive effect multilayered structure formed on the lower electrode layer;
a magnetic domain controlling bias layer made of a material at least partially including a hexagonal close-packed structure formed on both sides of the magnetoresistive effect multilayered structure along the track-width direction;
a metal layer made of a material having a body-centered cubic lattice structure formed on the magnetic domain controlling bias layer and the magnetoresistive effect multilayered structure to contiguously cover the magnetic domain controlling bias layer and the magnetoresistive effect multilayered structure; and
an upper electrode layer formed on the metal layer.

11. A method for manufacturing a magnetoresistive effect element using electric current in a direction perpendicular to layer planes, comprising the steps of:
forming a magnetoresistive effect multilayered structure on a lower electrode layer;
forming a magnetic domain controlling bias layer on both sides of the magnetoresistive effect multilayered structure along the track-width direction, the magnetic domain controlling bias layer at least partially including a hexagonal close-packed structure;
forming a first metal layer of a material having a body-centered cubic lattice structure on the magnetic domain controlling bias layer;
forming a second metal layer of a material having a body-centered cubic lattice structure on the first metal layer and the magnetoresistive effect multilayered structure to contiguously cover the first metal layer and the magnetoresistive effect multilayered structure; and
forming an upper electrode layer on the second metal layer.

12. A method for manufacturing a magnetoresistive effect element using electric current in a direction perpendicular to layer planes, comprising the steps of:
forming a magnetoresistive effect multilayered structure on a lower electrode layer;
forming a magnetic domain controlling bias layer on both sides of the magnetoresistive effect multilayered structure along the track-width direction, the magnetic domain controlling bias layer at least partially including a hexagonal close-packed structure;
forming a first metal layer of a material having a body-centered cubic lattice structure on the magnetic domain controlling bias layer;
planarizing the surface of the first metal layer and the magnetoresistive effect multilayered structure to remove at least a portion of the first metal layer;
forming a second metal layer of a material having a body-centered cubic lattice structure on the planarized surface to contiguously cover the first metal layer or the magnetic domain controlling bias layer, and the magnetoresistive effect multilayered structure; and
forming an upper electrode layer on the second metal layer.

13. The manufacturing method according to claim 11, wherein the first and second metal layers are formed of the same material having a body-centered cubic lattice structure.

14. The manufacturing method according to claim 11, further comprising the steps of:
forming an insulation layer on the lower electrode layer and on a side surface of the magnetoresistive effect multilayered structure; and
forming an under layer of a material having a body-centered cubic lattice structure on the insulation layer,
wherein the magnetic domain controlling bias layer is formed on the under layer.

15. The manufacturing method according to claim 14, wherein the under layer, the first metal layer and the second metal layer are formed of the same material having a body-centered cubic lattice structure.

16. A method for manufacturing a magnetoresistive effect element using electric current in a direction perpendicular to layer planes, comprising the steps of:
forming a magnetoresistive effect multilayered structure on a lower electrode layer;
forming a magnetic domain controlling bias layer on both sides of the magnetoresistive effect multilayered structure along the track-width direction, the magnetic domain controlling bias layer at least partially including a hexagonal close-packed structure;
forming a single metal layer of a material having a body-centered cubic lattice structure to contiguously cover the magnetic domain controlling bias layer and the magnetoresistive effect multilayered structure on the magnetic domain controlling bias layer and the magnetoresistive effect multilayered structure; and
forming an upper electrode layer on the single metal layer.

17. The manufacturing method according to claim 16, further comprising the steps of:
forming an insulation layer on the lower electrode layer and on a side surface of the magnetoresistive effect multilayered structure; and
forming an under layer of a material having a body-centered cubic lattice structure on the insulation layer;
wherein the magnetic domain controlling bias layer is formed on the under layer.

18. The manufacturing method according to claim 17, wherein the under layer and the metal layer are formed of the same material having a body-centered cubic lattice structure.

19. The manufacturing method according to claim 11, wherein high-temperature annealing is performed at a predetermined temperature or higher after the step of forming the upper electrode layer.

20. The manufacturing method according to claim 11, wherein the magnetoresistive effect multilayered structure is formed by forming a magnetoresistive effect multilayered film on the lower electrode layer and performing milling through a mask formed on the magnetoresistive effect multilayered film.

21. The manufacturing method according to claim 11, wherein after forming a film for a magnetic domain controlling bias layer through a mask, the mask is lifted off to form the magnetic domain controlling bias layer.

22. The manufacturing method according to claim 11, wherein the material having a body-centered cubic lattice structure is one selected among Cr, W, Ti, Mo, a CrTi alloy, a TiW alloy, a WMo alloy and a metal mainly including Cr, W, Ti, Mo, a CrTi alloy, a TiW alloy, or a WMo alloy.

23. The manufacturing method according to claim 11, wherein the material at least partially including a hexagonal close-packed structure is an alloy mainly including Co.

24. The manufacturing method according to claim 11, wherein a tunnel magnetoresistive effect multilayered film or a giant magnetoresistive multilayered film with a current-perpendicular-to-plane structure is formed for the magnetoresistive effect multilayered structure.

25. A method for manufacturing a thin-film magnetic head having a magnetoresistive effect element using electric current in a direction perpendicular to layer planes, comprising the steps of:
forming a magnetoresistive effect multilayered structure on a lower electrode layer;
forming a magnetic domain controlling bias layer on both sides of the magnetoresistive effect multilayered structure along the track-width direction, the magnetic domain controlling bias layer at least partially including a hexagonal close-packed structure;
forming a first metal layer of a material having a body-centered cubic lattice structure on the magnetic domain controlling bias layer;
forming a second metal layer of a material having a body-centered cubic lattice structure on the first metal layer and the magnetoresistive effect multilayered structure to contiguously cover the first metal layer and the magnetoresistive effect multilayered structure; and
forming an upper electrode layer on the second metal layer.
